(19) United States
(12) Patent Application Publication
(10) Pub. No.: US 2008/0097792 A1
(43) Pub. Date: Apr. 24, 2008

(54) Treatment Decision Support System and User Interface

(75) Inventor: Michelle MARGE, Landenberg, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS USA, INC., Malvern, PA (US)

(21) Appl. No.: 11/847,407

(22) Filed: Aug. 30, 2007

Related U.S. Application Data
(60) Provisional application No. 60/824,307, filed on Sep. 1, 2006.

(51) Int. Cl. G06Q 50/00

(52) U.S. Cl. 705/3

(57) ABSTRACT

A system provides clinicians with realtime medication suggestions. A treatment decision support system comprises at least one repository including information associating candidate treatment items, treatment costs, treatment supply availability, patient specific medical information and corresponding related treatment parameters. An individual treatment item is associated with multiple related treatment parameters. A communication processor accesses the information in the at least one repository. A treatment decision processor uses accessed information provided by the communication processor for providing data representing candidate treatments in response to user entry of data identifying an initial treatment based on both clinical and non-clinical factors. The non-clinical factors include lowest cost and availability and the clinical factors include patient specific medical information and predetermined treatment guidelines for treating a particular medical condition. A display processor provides data representing at least one display image identifying the candidate treatments.

This is a non-provisional application of provisional application Ser. No. 60/824,307 filed Sep. 1, 2006, by M. Marge.

### FIELD OF THE INVENTION

This invention concerns a treatment decision support system for providing data representing candidate treatments in response to user entry of treatment identification data as well as clinical and non-clinical factors.

### BACKGROUND OF THE INVENTION

Managing a patient medication regime is a complex and difficult task. There are numerous medications that may be prescribed to a patient to achieve a specific clinical goal. The medications may contain different ingredients, have different side effects, and work in different ways. Additionally, a specific medication dose may need to vary from patient to patient to achieve the same desired clinical effect. Determining which medication is the most effective for a particular patient condition requires continuous evaluation of current patient medical data as well as evaluation of past medications of a patient and reactions to medication. Significant treatment time may be wasted if current patient medical data is not monitored closely due to delay in accessing current patient medical data that resides in a multitude of different locations. A clinician may need to search for applicable patient medical data from a variety of sources including treatment order records, medication administration records, nursing assessment records, progress notes, History and Physical records and laboratory test results.

In known systems, a physician is not aware of pharmacy supply or cost when ordering treatments (including medications). Even with data electronically captured, the process of evaluating and analyzing patient medical data to determine medication treatment is typically manual and access to patient medical data in known distributed, non-integrated hospital information systems is time consuming and burdensome. Known systems further fail to comprehensively review and analyze an entire patient medication and diagnostic history in addition to current data to assist in medication selection. The sources of medical data of a particular patient for a single hospital stay or visit in a hospital (or other healthcare provider), are typically, distributed, of differing data format and isolated. Known systems rely on physician experience, thoroughness, and ability to stay up to date by reading medical journal articles and learning best practices, for example. This can cause a variety of inconsistent practices between physicians in a single institution or department or between physicians of different institutions. A system according to invention principles addresses these deficiencies and related problems.

### SUMMARY OF THE INVENTION

In known systems, a physician is not aware of pharmacy supply or cost when ordering treatments and typically does not have access to information to order the most cost effective form of a drug, for example. A system provides clinicians with real-time medication suggestions (using push and pull communication) by automatically parsing and evaluating patient information, including past and current medications, diagnostic findings (laboratory test results), patient assessments and cross referenced hospital definable medication treatment courses and pharmaceutical inventory and cost. A treatment decision support system comprises at least one repository including information associating candidate treatment items, treatment costs, treatment supply availability, patient specific medical information and corresponding related treatment parameters. An individual treatment item is associated with multiple related treatment parameters. A communication processor accesses the information in the at least one repository. A treatment decision processor uses accessed information provided by the communication processor for providing data representing candidate treatments in response to user entry of data identifying an initial treatment based on both clinical and non-clinical factors. The non-clinical factors include lowest cost and availability and the clinical factors include patient specific medical information and predetermined treatment Guidelines for treating a particular medical condition. A display processor provides data representing at least one display image identifying the candidate treatments.

### BRIEF DESCRIPTION OF THE DRAWING

FIG. 1 shows a treatment decision support system, according to invention principles.

FIG. 2 shows a treatment decision support system illustrating system operation, according to invention principles.

FIG. 3 shows a user interface display image window enabling a physician to order treatments from candidates suggested by the treatment decision support system, according to invention principles.

FIG. 4 shows a user interface display image window illustrating alert messages provided by the treatment decision support system, according to invention principles.

FIG. 5 shows a flowchart of a process performed by a treatment decision support system, according to invention principles.

### DETAILED DESCRIPTION OF THE INVENTION

A system provides clinicians with real-time candidate medication suggestions for a patient based on evidence based medication treatment plans and individual patient medication and diagnostic history. The system parses and evaluates patient information, including past and current medications, diagnostic findings (laboratory test results) and patient assessments. The system cross references (associates) hospital definable medication treatment courses with a pharmaceutical (medication) inventory and related costs. The system communicates medication suggestions to clinicians by both push and pull methods for storage and display on a workstation, for example.

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor may comprise a combination of, hardware, firmware, and/or software.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface (UI), as used herein, comprises one or more display images, generated by a display processor and enabling user interaction with a processor or other device and associated data acquisition and processing functions.

The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity. Workflow comprises a sequence of tasks performed by a device or worker or both. An object or data object comprises a grouping of data, executable instructions or a combination of both or an executable procedure.

A workflow processor, as used herein, processes data to determine tasks to add to a task list, remove from a task list or modifies tasks incorporated on, or for incorporation on, a task list. A task list is a list of tasks for performance by a worker or device or a combination of both. A workflow processor may or may not employ a workflow engine. A workflow engine, as used herein is a processor executing in response to predetermined process definitions that implement processes responsive to events and event associated data. The workflow engine implements processes in sequence and/or concurrently, responsive to event associated data to determine tasks for performance by a device and or worker and for updating task lists of a device and a worker to include determined tasks. A process definition is definable by a user and comprises a sequence of process steps including one or more, of start, wait, decision and task allocation steps for performance by a device and or worker, for example. An event is an occurrence affecting operation of a process implemented using a process definition.

A Workflow Management System is a software system that manages processes. It includes a process definition function that allows users to define a process that should be followed, an Event Monitor, which captures events from a Healthcare Information System and communicates the results to the Workflow Management System. A processor in the Management System tracks which processes are running, for which patients, and what step needs to be executed next, according to a process definition. The Management System includes a procedure for notifying clinicians of a task to be performed, through their worklists and a procedure for allocating and assigning tasks to specific users or specific teams. A document or record comprises a compilation of data in electronic form and is the equivalent of a paper document and may comprise a single, self-contained unit of information.

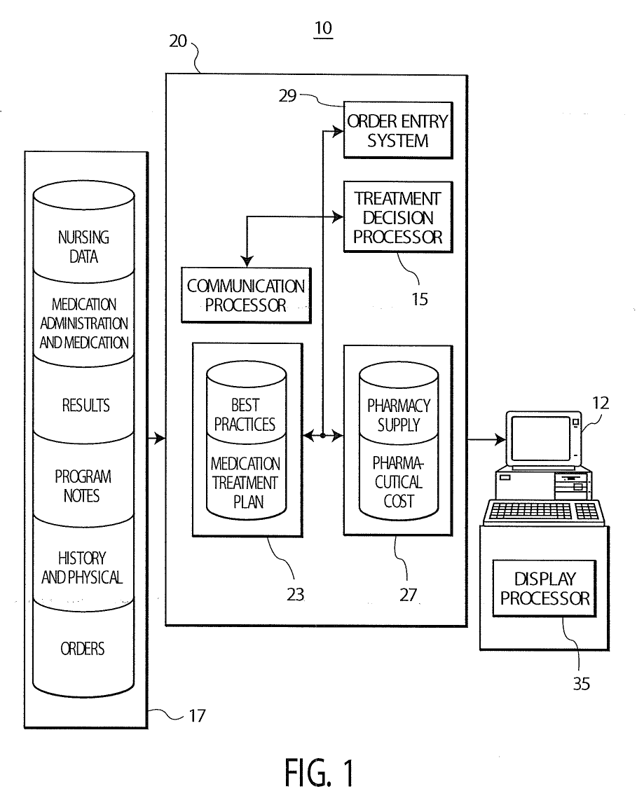

FIG. 1 shows treatment decision support system 10 for retrieving and analyzing patient data to determine an optimum medication treatment for a patient. A clinician may request candidate medication suggestions during placement of an order for medication to be administered to a patient using Computerized Order Entry (CPOE) system 29. System 10 also automatically provides candidate medication suggestions in response to receiving updated data from at least one repository (e.g., repository 17) such as physician entered medication order data, nursing data, laboratory test results, progress notes, history and physical data and medication administration and medication history data. Repositories 17, 23 and 27 in treatment decision support system 10, also incorporate information associating, candidate treatment items, treatment costs, treatment supply availability, patient specific medical information and corresponding related treatment parameters. An individual treatment item is associated with multiple related treatment parameters. Communication processor 20 accesses information in repositories 17, 23 and 27. Treatment decision processor 15 uses accessed information provided by communication processor 20 for providing data representing candidate treatments in response to user entry of data identifying an initial treatment based on both clinical and non-clinical factors. The non-clinical factors include lowest cost and availability and the clinical factors include patient specific medical information and predetermined treatment guidelines for treating a particular medical condition. Display processor 35 in workstation 12 provides data representing at least one display image identifying the candidate treatments.

In an operation example, a physician desires to order Aspirin for a patient and initiates analysis by treatment decision processor 15 via a display image presented on workstation 12 to provide candidate suggestions. Treatment decision processor 15 searches patient data in repositories 17 and 23 and finds within patient assessment records in the nursing data in repository 17 that a patient has been documented with a decreased appetite and that a decreased percentage of meals is being consumed. Treatment decision processor 15 also finds that the patient has requested and has been administered a PRN (Prescription Required as Needed) medication (Maalox). Both findings suggest the patient may be experiencing gastric irrigation. Treatment decision processor 15 employs best practices, treatment guidelines, inventory and cost data derived from repositories 23 and 27 to recommend that a physician order enteric-coated aspirin from Vendor X. Specifically, processor 45 queries pharmacy inventory data in repository 27 and determines enteric-coated aspirin from Vendor X is in higher supply due to a reduced price last month. Treatment decision processor 15 also provides candidate medication suggestions in response to entry of new data. For example, a patient is admitted with angina. In an Emergency Room (ER) a battery of tests is performed. Treatment decision processor 15 determines a new laboratory test result is acquired with an INR (International Normalized Result) of 1.2. Processor 15 also determines patient current cardiac rhythm is atrial fibrillation and initiates generation of an alert message for communication via processor 20 and workstation 12 to a clinician indicating the INR result is 1.2 and the cardiac rhythm is atrial fibrillation and alerts a physician that it may be advisable to increase coumadin (warafin) dosage.

Treatment decision processor 15 searches for data to analyze and provide a clinician with candidate medication suggestions for ordering. Processor 15 searches through data indicating current and past patient medications to provide candidate medication suggestions compatible with current medication orders of a patient. Processor 15 employs Best Practice Medication guidelines and planning rules derived from repository 23 to provide candidate medication suggestions that comply with best practice recommendations and hospital defined medication treatment plans. Treatment decision processor 15 employs financial (including cost) information to provide candidate medication suggestions to a clinician enabling selection of a financially appropriate medication. Processor 15 provides information regarding cost of treatment and also analyzes data from repositories 17, 23 and 27 to provide candidate medication suggestions based on cost of medication whilst maintaining clinical effectiveness and minimizing side effects and other adverse medication consequences for a particular patient. A physician employs processor 15 in ordering cost effective medications that advantageously obviates a need for a pharmacist to modify medication orders or call a physician to substitute a medication for inventory supply and/or cost reasons. Candidate medication suggestions and associated cost, supply and clinical (including adverse consequence) information is pushed directly to a physician. In another embodiment the information is acquired in response to physician command. Additionally, system 10 comprises an integrated system that automatically acquires and processes patient medical data, financial data, and evidence-based medicine practices and guidelines from repositories 17, 23 and 27 to provide a clinician with candidate medication suggestions based on the most recent relevant information available. System 10 ensures that best practices and just in time information are widely disseminated to clinicians regardless of individual clinician continuing education practices.

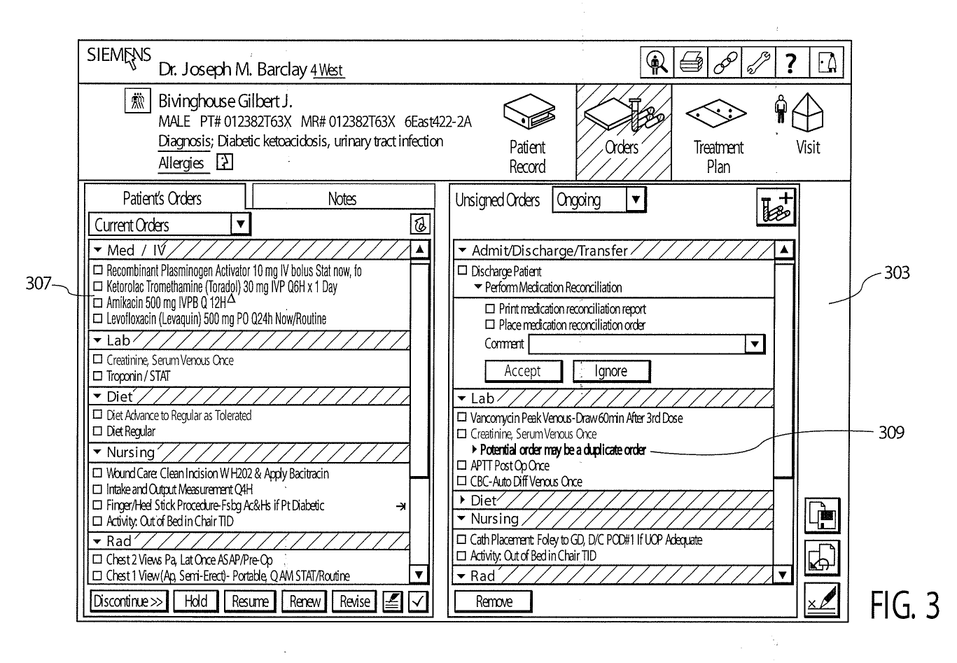

FIG. 3 shows a user interface display image window 303, provided by workstation 12, enabling a physician to order treatments from candidates suggested by treatment decision processor 15 during an ordering session. Image window 303 includes Medication/IV treatment list area 307 illustrates four medications suggested by processor 15 for order by a physician. Processor 15 provides data indicating the four medications by analyzing data from repositories 17, 23 and 27 to provide candidate medication suggestions based on cost of medication whilst maintaining clinical effectiveness and minimizing side effects and other adverse medication consequences for a particular patient. Alert message 309 provided by processor 15, indicates an order may be a potential duplicate order.

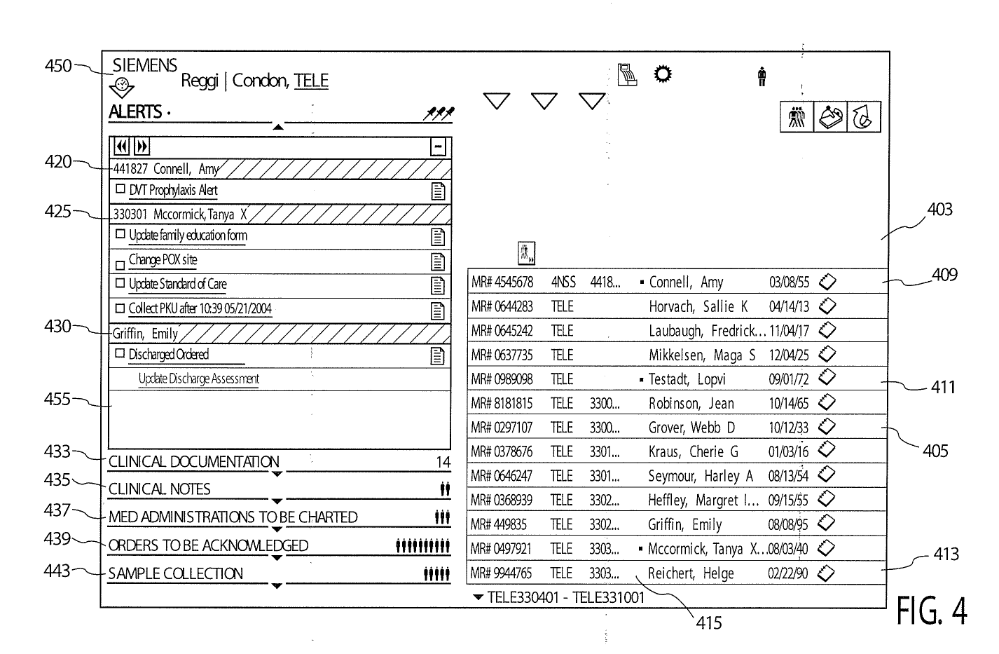

FIG. 4 shows user interface display image window 403 showing alert messages and an associated task list for clinician 450 provided by treatment decision processor 15 for multiple different patients identified in window area 405. Specifically, area 405 indicates in column 415, that three patients identified in rows 409, 411 and 413 await tasks to be performed. Window area 455 indicates an alerts task list for clinician 450 provided by a workflow engine within treatment decision processor 15. The task list includes task lists 420, 425 and 430 to be performed for patients of rows 409, 411 and 413 respectively. Display image window 403 also enables a user to access data and perform related functions for patients identified in area 405 by selection of links. Specifically, a user is able to select links concerning patient clinical documentation 433, clinical notes 435, medication administrations to be recorded 437, orders to be acknowledged 439 and sample collection 443.

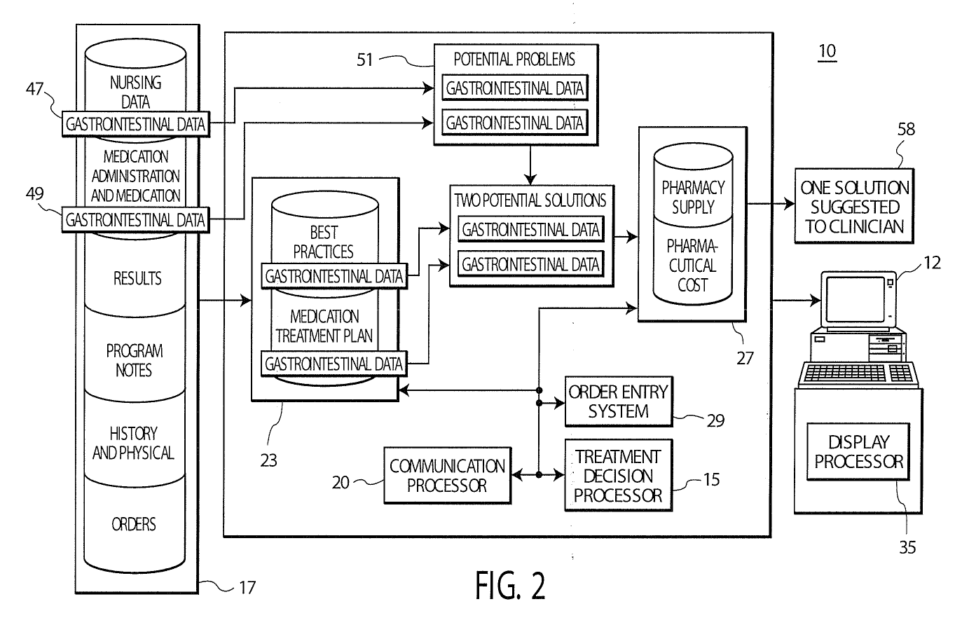

FIG. 2 shows treatment decision support system 10 illustrating system operation. System 10 advantageously analyzes and processes nursing data and financial data in suggesting candidate medications and allows determination of a clinical “path” to follow. Treatment decision processor 15 determines candidate medications by systematically correlating and processing clinical data to derive medication candidates. For this purpose, processor 15 reviews and compares data from different physiological disciplines that is clinically linked by predetermined linking information in repositories 17, 23 and 27. The data is clinically linked by associating specific hospital selected data with category groupings that can be compared. Candidate medications are determined based on the comparison of groupings to hospital best practices and predetermined treatment protocols. Category data is also compared with specific data from other databases that is associated with a corresponding category grouping.

In connection with the example of operation previously described concerning FIG. 1 involving suggestion of enteric-coated aspirin from Vendor X, a nurse performs a patient review or patient assessment and enters data indicating a finding into system 10. Specifically, the nurse enters data indicating a Percentage of meals consumed and treatment decision processor 15 automatically associates the finding with a category (Gastrointestinal) and stores the finding in this category in a section of nursing data in repository 17 (item 47) and in this category in medication administration data in repository 17 (item 49). In another embodiment, a nurse associates the finding with the Gastrointestinal category by manual association via a user interface display image.

Medications in repository 17 have one or multiple categories associated with therapeutic treatments. Maalox is considered an Anti-Ulcer/Antacid, which is also in the gastrointestinal category. Treatment decision processor 15 automatically applies best practices and guidelines and medication treatment plan data in repository 23 in determining a positive gastrointestinal symptom indicated in the nursing data plus a prescribed Gastrointestinal medication equals a Potential Gastrointestinal problem 51 for a particular patient. Processor 15 additionally queries patient medication information in repository 17 to see if any of the patient prescribed medications have a gastrointestinal side effect. Processor 15 finds that the patient is taking Aspirin. A hospital has previously configured the system to query for specific coated medications when a patient is found to have Gastrointestinal problems. Processor 15 automatically queries a Pharmacy supply list in repository 27 and finds enteric-coated aspirin and two vendors listed as suppliers of the aspirin 54. Treatment decision processor 15 reviews financial listings and data and pharmacy inventory in suggesting a single candidate best medication 58 based on total cost paid and total quantity in the inventory.

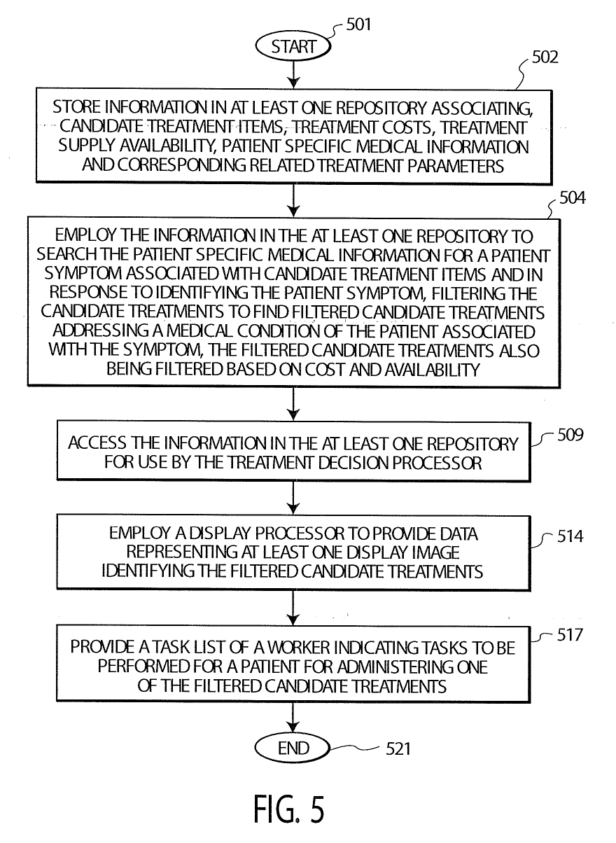

FIG. 5 shows a flowchart of a process performed by a treatment decision support system. The steps of FIG. 5 may be performed automatically. In step 502 following the start at step 501, information is stored in at least one repository (e.g., repositories 17, 23 and 27) including information associating, candidate treatment items, a therapeutic treatment category, treatment costs, treatment supply availability, patient specific medical information and corresponding related treatment parameters. An individual treatment item is associated with multiple related treatment parameters. The patient specific information includes at least two of treatment order information, medication administration records, nursing assessment information, progress notes, history and physical examinations and laboratory test results. The related treatment parameters identify quantity, a route of administration of a medical treatment, a frequency of administering a treatment and a form of medical treatment. The form of medical treatment comprises at least one of, a package type, a strength of a medical treatment and a concentration of a medical treatment.

In step 504, treatment decision processor 15 uses information accessed from the at least one repository (by communication processor 20) to search the patient specific medical information for a patient symptom associated with candidate treatment items. In response to identifying the patient symptom, treatment decision processor 15 filters the candidate treatments to find filtered candidate treatments addressing a medical condition of the patient associated with the symptom. The filtered candidate treatments are also filtered by processor 15 based on cost and availability. Processor 15 also provides data representing candidate treatments in response to user entry of data identifying an initial treatment based on both clinical and non-clinical factors. The non-clinical factors include lowest cost and availability and the clinical factors include patient specific medical information and predetermined treatment guidelines for treating a particular medical condition. Treatment decision processor 15 in one embodiment uses information in the at least one repository (17, 23 and 27) to search the patient specific medical information for a patient symptom associated with the therapeutic treatment category and in response to identifying the patient symptom, employs predetermined treatment guidelines to derive the candidate treatments addressing a medical condition of the patient associated with the symptom and filtering the candidate treatments based on cost and availability to provide filtered candidate treatments.

In step 509 communication processor 20 accesses the information in the at least one repository for use by treatment decision processor 15. Display processor 35 provides data representing at least one display image identifying the filtered candidate treatments in step 514. In one embodiment, the at least one display image comprises a single display image. A workflow engine in processor 15 provides a task list for a worker indicating tasks to be performed for a patient for administering one of the filtered candidate treatments in step 517. The workflow engine, in response to a process definition, provides multiple task lists indicating tasks to be performed for corresponding multiple different patients and the tasks are identified by corresponding alert messages. The alert messages include an alert message indicating a candidate treatment for administration to a particular patient provided by treatment decision processor 15. Display processor 35 also initiates generation of data representing at least one display image including, multiple task lists indicating tasks to be performed for corresponding multiple different patients and a candidate treatment for administration to a particular patient provided by treatment decision processor 15. The candidate treatment is indicated in an alert message communicated to a user. FIG. 5 terminates at step 521.

The system and process of FIGS. 1, 2 and 5 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. The treatment decision support system provides clinicians with real-time medication suggestions in response to cost and availability. The inventive principles are applicable to different healthcare and non-healthcare fields. The processes and applications may in alternative embodiments, be located on one or more (e.g., distributed) processing devices accessing a network linking the elements of FIG. 1. Further, any of the functions and steps provided in FIGS. 1, 2 and 5 may be implemented in hardware, software or a combination of both and may reside on one or more processing devices located at any location of a network linking the elements of FIG. 1 or another linked network including the Internet.

What is claimed is:

1. A treatment decision support system, comprising:
at least one repository including information associating, candidate treatment items, treatment costs, treatment supply availability, patient specific medical information and corresponding related treatment parameters, an individual treatment item being associated with a plurality of related treatment parameters;
a communication processor for accessing said information in said at least one repository;
a treatment decision processor for using accessed information provided by said communication processor for providing data representing candidate treatments in response to user entry of data identifying an initial treatment based on both clinical and non-clinical factors,
said non-clinical factors including lowest cost and availability and
said clinical factors including patient specific medical information and predetermined treatment guidelines for treating a particular medical condition; and
a display processor for providing data representing at least one display image identifying said candidate treatments.

2. A system according to claim 1, wherein
said patient specific information includes at least two of, (a) treatment order information, (b) medication administration records, (c) nursing assessment information, (d) progress notes, (e) history and physical examinations and (f) laboratory test results.

3. A system according to claim 1, wherein
said at least one repository includes information associating a candidate treatment item with a therapeutic treatment category and
said treatment decision processor uses information in said at least one repository to search said patient specific medical information for a patient symptom associated with said therapeutic treatment category and in response to identifying said patient symptom employs predetermined treatment guidelines to derive said candidate treatments addressing a medical condition of said patient associated with said symptom.

4. A system according to claim 1, including
a workflow engine for providing a plurality of task lists indicating tasks to be performed for a corresponding plurality of different patients and
said tasks are identified by corresponding alert messages.

5. A system according to claim 4, including
a workflow engine responsive to a process definition for providing a plurality of task lists indicating tasks to be performed for a corresponding plurality of different patients.

6. A system according to claim 4, wherein
said alert messages include an alert message indicating a candidate treatment for administration to a particular patient provided by said treatment decision processor.

7. A system according to claim 1, including
a display processor for initiating generation of data representing a single display image including,
a plurality of task lists indicating tasks to be performed for a corresponding plurality of different patients and
a candidate treatment for administration to a particular patient provided by said treatment processor.

8. A system according to claim 7, wherein
said candidate treatment is indicated in an alert message to a user.

9. A treatment decision support system, comprising:
at least one repository including information associating, candidate treatment items, treatment costs, treatment supply availability, patient specific medical information and corresponding related treatment parameters, an individual treatment item being associated with a plurality of related treatment parameters;
a treatment decision processor for using said information in said at least one repository to search said patient specific medical information for a patient symptom associated with candidate treatment items and in response to identifying said patient symptom, filtering said candidate treatments to find filtered candidate treatments addressing a medical condition of said patient associated with said symptom, said filtered candidate treatments also being filtered based on cost and availability;
a communication processor for accessing said information in said at least one repository for use by said treatment decision processor; and
a display processor for providing data representing at least one display image identifying said filtered candidate treatments; and
a workflow engine for providing a task list of a worker indicating tasks to be performed for a patient for administering one of said filtered candidate treatments.

10. A system according to claim 9, including
a display processor for initiating generation of data representing at least one display image including,
a plurality of task lists indicating tasks to be performed for a corresponding plurality of different patients and
a candidate treatment for administration to a particular patient provided by said treatment decision processor.

11. A system according to claim 10, wherein
said at least one display image comprises a single display image.

12. A treatment decision support system, comprising:
at least one repository including information associating, candidate treatment items, therapeutic treatment category, treatment costs, treatment supply availability, patient specific medical information and corresponding related treatment parameters, an individual treatment item being associated with a plurality of related treatment parameters;
a treatment decision processor for using said information in said at least one repository to search said patient specific medical information for a patient symptom associated with said therapeutic treatment category and in response to identifying said patient symptom employing predetermined treatment guidelines to derive said candidate treatments addressing a medical condition of said patient associated with said symptom and filtering said candidate treatments based on cost and availability to provide filtered candidate treatments;
a communication processor for accessing said information in said at least one repository for use by said treatment decision processor; and
a display processor for providing data representing at least one display image identifying said filtered candidate treatments.

13. A system according to claim 12, wherein
said related treatment parameters identify at least one of, (a) quantity, (b) a route of administration of a medical treatment, (c) a frequency of administering a treatment and (d) a form of medical treatment.

14. A system according to claim 13, wherein
said form of medical treatment comprises at least one of, (a) a package type, (b) a strength of a medical treatment and (c) a concentration of a medical treatment.
